(19) United States
(12) Patent Application Publication
(10) Pub. No.: US 2014/0311980 A1
(43) Pub. Date: Oct. 23, 2014

(54) System to Provide a Supply of Controlled Salinity Water for Enhanced Oil Recovery

(71) Applicants: Robert Charles William Weston, Berkshire (GB); Gary Howard Mellor, Berkshire (GB)

(72) Inventors: Robert Charles William Weston, Berkshire (GB); Gary Howard Mellor, Berkshire (GB)

(21) Appl. No.: 13/186,837

(22) Filed: Jul. 20, 2011

(51) Int. Cl. C02F 1/44

(52) U.S. Cl. 210/652

(57) ABSTRACT

A method for providing controlled salinity water for enhanced oil recovery begins by raising the pressure of, and then splitting, a treated seawater feed into two supply streams which are then processed in parallel. One supply stream is passed thorough a nanofiltration membrane system while the other is passed through a reverse osmosis membrane system. The permeate streams are then combined for an overall recovery factor in a range of 50% to 65%. The pressure of the first supply stream is preferably reduced prior to treatment and the nanofiltration membrane system may be housed in a pressure vessel rated for use with a reverse osmosis membrane system. Energy can be recovered from the nanofiltration reject stream or the reverse osmosis reject and used to reduce the feed pumping power or provide an inter-stage pressure boost. The single seawater feed allows for a simplified pumping and piping arrangement.

### BACKGROUND OF THE INVENTION

Enhanced oil recovery from fields can be accomplished by injecting polymer solutions into the oil bearing reservoir. For optimal performance, the polymer solution should use water having a salinity content in a range of about 4,000 to 10,000 mg/L and a low divalent ion (e.g. sulphate, calcium) and hardness content.

Published PCT Application WO 2007/138327 discloses a water treatment system and a method of providing a supply of water of controlled salinity suitable for injection into an oil bearing reservoir. The system and method includes the steps of: substantially desalinating a first feed supply of water to provide a first supply of treated water of low salinity; treating a second feed supply of water to provide a second supply of treated water having a reduced concentration of divalent ions in comparison to the second feed supply and a higher salinity than the first supply of treated water; and mixing the first supply of treated water and the second supply of treated water to provide a supply of mixed water having a desired salinity suitable for injection into an oil bearing reservoir. The first feed supply is preferably treated by reverse osmosis (RO). The second feed supply is preferably treated by nanofiltration (NF). Published PCT Application WO 2007/138327 is herein incorporated by reference in its entirety.

Others have approached the problem of providing water which has the preferred salinity characteristics by first treating seawater with NF and then treating the resulting NF permeate (low sulphate and low hardness water) with RO. For example, Ayirala et al.—in a paper published by the Society of Petroleum Engineers in 2010, numbered SPE 12996, and titled, “A Designer Water Process for Offshore Low Salinity and Polymer Flooding Applications”—disclose a system and method in which filtered seawater first passes through two NF stages and the NF permeate then passes through two RO stages. The RO permeate is then blended with the NF reject and RO reject streams. The Ayirala paper is herein incorporated by reference in its entirety.

A problem with the above serial-type systems and methods is the serial combination limits the overall recovery factor to about 40% to 50% (feed to product). The method also requires separate NF (typically about a 75% recovery factor) and RO (typically about 50% to 65%) systems, each with a dedicated feed pressurization system. Additionally, as the produced water flow increases in later field life, the produced water is typically re-injected into the formation after mixing with RO permeate. This makes the requirement for NF redundant while at the same time creating a bottleneck because the RO system lacks sufficient capacity for the new processing demands placed upon it.

Therefore, a need exists to provide a combination of NF and RO membranes which provides the desired salinity level while at the same time increasing the overall recovery factor with reduced equipment space and weight requirements.

### SUMMARY OF THE INVENTION

A system and method for providing a supply of controlled salinity water for enhanced oil recovery includes the steps of:
i. raising a pressure of a treated seawater feed stream having a salinity content above 10,000 mg/L;
ii. splitting the raised pressure treated seawater feed stream into a first supply stream and a second supply stream;
iii. treating in parallel the first and second supply streams, the first supply stream being treated by passing it through a nanofiltration membrane system and the second supply stream being treated by passing it through a reverse osmosis membrane system; and
iv. blending a nanofiltration permeate stream from the nanofiltration membrane system with a reverse osmosis permeate stream from the reverse osmosis membrane to achieve a mixed supply water stream having a salinity in a range of about 4,000 to 10,000 mg/L and a divalent ion concentration less than that of the treated feedwater feed stream.

The overall recovery factor of the above method is in a range of 50% to 65% (and can range between 45% and 75%), with the nanofiltration membrane system and the reverse osmosis membrane system each preferably having about the same recovery factor. The nanofiltration membrane system may be housed in a pressure vessel rated for use with a reverse osmosis membrane system.

The pressure raising step may be accomplished using a simplified pumping and piping arrangement because a common feed pressurization system can be employed. The pressure of the first supply stream can then be reduced by way of pressure reducing valves or an energy recovery device prior to its treating step.

Energy can be recovered from a nanofiltration reject stream or a reverse osmosis reject stream (or both streams) and used to reduce the feed pumping power. In applications in which the method employs multiple stages, the recovered energy can be used to provide an inter-stage pressure boost.

Objects of this invention are to provide a system that (1) relies upon a simplified operating control system, including an on-line conductivity measurement control; (2) operates the NF and RO systems in parallel, with appropriate NF/RO permeate blending to achieve the desired salinity level; (3) allows the NF membranes to be installed in pressure vessels rated for RO service, thereby permitting change-out of the NF membranes to RO membranes in later field life; (4) uses a single membrane system in which the NF and RO membranes operate at the same or similar recovery factors; (5) achieves an NF recovery factor in a range of 45% to 85% and a RO recovery factor in a range of 45% to 75% with both recovery factors preferably being about the same or similar in a range of 50% to 65%; (6) accomplishes a high overall recovery factor (about 45% to 75% with 50% to 65% being typical) while minimizing weight and space requirements for the pre-treatment system; (7) uses a simplified pumping and piping arrangement because of a common NF/RO feed pressurization system; and (8) can use energy recovery devices to reduce the feed pressure required for NF operation.

### BRIEF DESCRIPTION OF THE DRAWINGS

FIG. 1 is a schematic of a prior art system and method to provide a supply of controlled salinity water for enhanced oil recovery. Pre-treated seawater is split into two streams, with one stream passing through two stages of reverse osmosis (RO) and the other stream, along with an RO reject stream, passing through two stages of nanofiltration (NF). The RO and NF permeate are then blended.

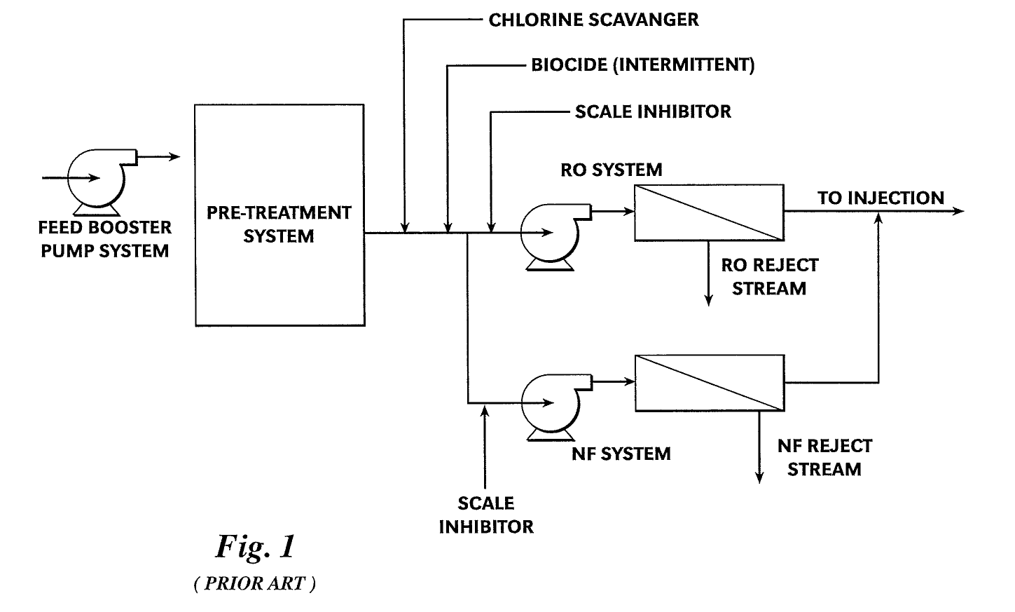

FIG. 2 is a schematic of another prior art system and method to provide a supply of controlled salinity water for enhanced oil recovery. Pre-treated seawater passes through two NF stages and the NF permeate passes through two RO stages. The RO permeate is then blended with the NF reject and RO reject streams.

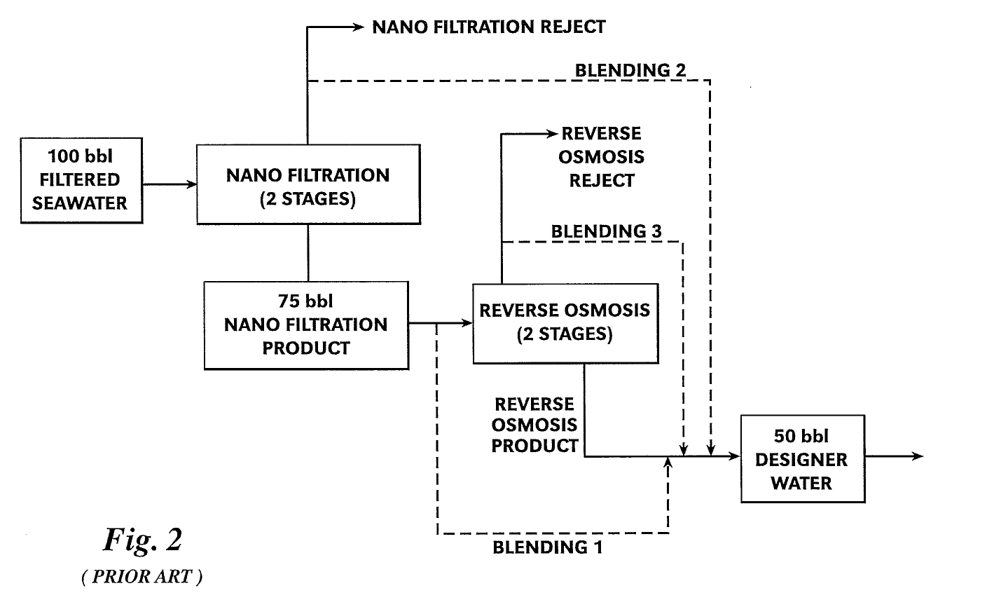

FIG. 3 is a schematic of a preferred embodiment of a system and method practiced according to this invention. Pre-treated seawater is split into two streams, with the first stream passing through a single stage of NF and the second streampassing through a single stage of RO. The first stream is preferably at a lower pressure than the second stream. A portion of the NF permeate may be blended with the RO permeate.

List of Element Numbers Used in the Drawings

| | |
|---|---|
| 10 | Water treatment system |
| 11 | Treated seawater stream |
| 13 | High-pressure boost pump system |
| 15 | Raised pressure feed stream |
| 17 | Pressure reducing device |
| 21 | First supply stream |
| 23 | Nanofiltration (NF) membrane system |
| 25 | NF permeate stream |
| 27 | NF reject stream |
| 35 | NF permeate stream |
| 33 | Portion of NF permeate production |
| 41 | Second supply stream |
| 43 | Reverse osmosis (RO) membrane system |
| 45 | RO permeate stream |
| 47 | RO reject stream |
| 61 | Mixed water supply |

### DETAILED DESCRIPTION OF THE PREFERRED EMBODIMENTS

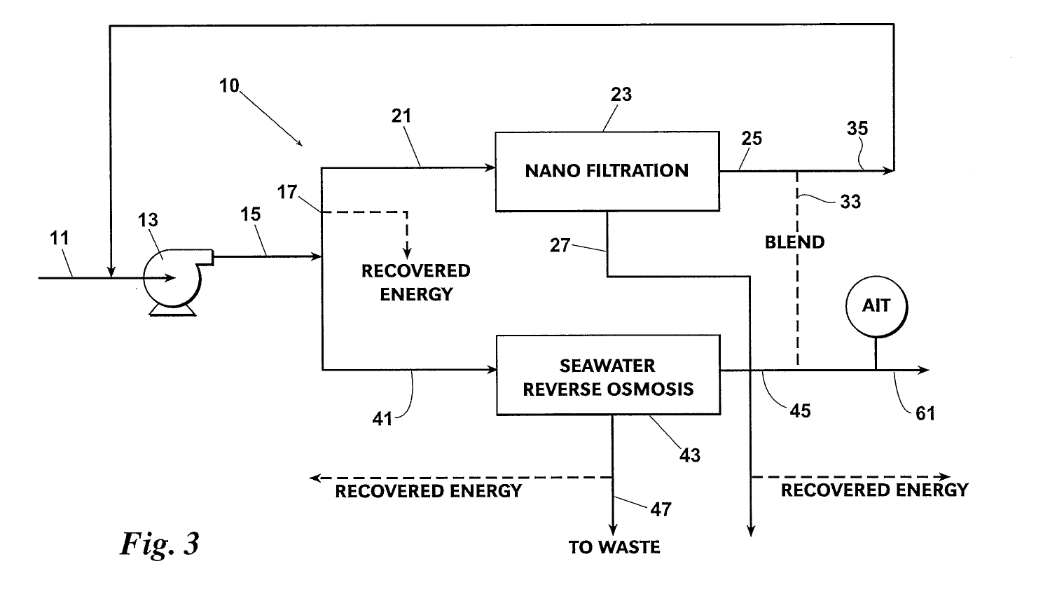

Referring to FIG. 3, a water treatment system 10 for providing a supply of controlled salinity water for enhanced oil recovery operates the nanofiltration (NF) and reverse osmosis (RO) systems in parallel and relies upon an on-line conductivity measurement control system (AIT) to determine the amount of NF and RO permeate being blended in order to achieve a desired salinity level.

Water treatment system 10 begins with a treated seawater stream 11, which has been pre-treated and filtered by well-known methods to reduce particulate matter, chlorine content, biological activity and scaling. Treated seawater stream 11 is routed into a common high-pressure boost pump system 13 to create a raised-pressure feed stream 15. The raised pressure feed stream 15 is split into two supply streams 21, 41. The first supply stream 21 is used to supply a NF membrane system 23. The second supply stream 41 is used to supply a RO membrane system 43.

Unlike prior art systems, which rely upon a separate high-pressure booster pump system 13 for each supply stream 21, 41, a common NF/RO feed pressurization system is employed here. Also, because the pressure required for the NF membrane system 23 is lower than that required for the RO membrane system 43, a pressure reducing device 17, such as a pressure reduction valve or an energy recovery system may be employed on the first (NF) supply stream 21.

Despite the reduced pressure requirements for the NF membrane system 23, and unlike prior art systems, the NF membrane system can be housed in a pressure vessel rated for RO membrane system 43 service. This permits a change-out in later field life of the NF membrane system 23 to a supplemental RO membrane system 43. Because the amount of produced water flow increases in later field life, the NF membrane system 23 becomes redundant and the RO membrane system 43, if not augmented by an additional RO membrane system, typically lacks sufficient capacity for the new processing demands placed upon it. System 10 allows for the NF membrane system 23 to be easily re-deployed and placed into service as additional RO membrane capacity.

The NF membrane system 23 results in a permeate stream 25 and a reject stream 27 which is discharged to waste. Depending on the desired salinity level of the final, mixed water supply 61, a first portion 33 of the NF permeate stream 25 may be mixed with the RO membrane system 43 permeate steam 45. Excess NF permeate production may be recycled upstream of the high-pressure boost pump system 13, where the portion 35 is blended with the feed water stream 11.

The RO membrane system 43 system results in a permeate stream 45 and a reject stream 47 which is discharged to waste. The salinity of the RO permeate stream 45 is extremely low, and in fact is somewhat lower than the optimal range of salinities for oil recovery applications in which the water is injected into an oil bearing reservoir. The salinity of the NF permeate stream 25 is considerably higher than the salinity of the RO permeate stream 45; however, the concentration of certain, undesirable divalent cations, principally Ca2+, is greatly reduced by the NF membrane system 23. Therefore, a portion 33 of the NF permeate stream 25 is mixed with the RO permeate stream 45 at a desired mixing ratio in order to produce a mixed water supply 61 which may be injected into an oil bearing reservoir for oil recovery purposes.

The NF membrane system 23 and the RO membrane system 43 each use a single membrane system in which the NF and RO membranes operate at the same or similar recovery factors. The NF membrane system preferably achieves an NF recovery factor in a range of 50% to 65% (but could be in a range of 45% to 85%) and the RO membrane system preferably achieves an RO recovery factor in a range of 50% to 65% (but could be in a range of 45% to 75%). An overall high recovery factor is therefore obtained relative to prior art systems. A further advantage relates to the concentration of divalent ions (e.g. sulfate, calcium, and hardness content) in the mixed water supply 61. If the concentration of divalent ions in the water supplied to an oil bearing reservoir is above a certain level, then there is a risk that damage may be caused, for example by precipitation of generated surfactants. The reduction in the divalent ion concentration of the NF permeate stream 25 leads to a mixed water supply 61 that has relatively low concentrations of divalent ions.

The mixing of the NF and RO permeate streams 25, 45, in particular their relative proportions, can be controlled manually or automatically using a suitable flow control system. Such flow control systems are well known to those skilled in the art. It is particularly preferred that an automatic flow control system is utilized that controls the mixing in accordance with a measured variable. For example, conductivity readings of the mixed water supply 61 can be taken as a measure of the total dissolved solids content, and used to control the mixing of the NF and RO permeate streams 25, 45. Suitable control systems, which might incorporate a microprocessor, would readily suggest themselves to the skilled reader. The flow rate of the mixed water supply 61 might be controlled in a similar manner. Furthermore, it is possible to make other measurements, such as measurements of calcium ion concentration, and to use these measurements to control the water treatment system 10. It may be necessary to augment these readings with laboratory testing in order to ensure that the system is performing according to expectation. In further embodiments, data relating to in-situ measurements made on the water treatment system 10 are conveyed to a central monitoring location by suitable means, such as by telemetry or over the Internet.

While preferred embodiments of a system to provide a supply of controlled salinity water for enhanced oil recovery have been described with a certain degree of particularity, the following claims define the scope of the invention.

What is claimed is:

1. A method for providing a supply of controlled salinity water for enhanced oil recovery, the method comprising the steps of:
raising a pressure of a treated seawater feed stream, the treated seawater feed stream having a salinity content above 10,000 mg/L;
splitting the raised pressure treated seawater feed stream into a first supply stream and a second supply stream;
treating in parallel the first and second supply streams, the first supply stream being treated by passing it through a nanofiltration membrane system and the second supply stream being treated by passing it through a reverse osmosis membrane system; and
blending a nanofiltration permeate stream from the nanofiltration membrane system with a reverse osmosis permeate stream from the reverse osmosis membrane to achieve a mixed supply water stream having a salinity in a range of about 4,000 to 10,000 mg/L and a divalent ion concentration less than that of the treated feedwater feed stream;
the nanofiltration membrane system and the reverse osmosis membrane system each having about the same recovery factor.

2. A method according to claim 1 wherein the nanofiltration membrane system is housed in a pressure vessel rated for use with a reverse osmosis membrane system.

3. A method according to claim 1 wherein the pressure raising step is accomplished using a common feed pressurization system.

4. A method according to claim 1 further comprising the step of reducing a pressure of the first supply stream prior to the treating step.

5. A method according to claim 4 wherein the pressure reducing step is accomplished using at least one of a pressure reducing valve and an energy recovery device.

6. A method according to claim 1 wherein the recovery factor is in a range of 50% to 65%.

7. A method according to claim 1 wherein an overall recovery factor is in a range of 45% to 75%.

8. A method according to claim 7 wherein the overall recovery factor is in a range of 50% to 65%.

9. A method according to claim 1 further comprising the step of recovering energy from at least one of a nanofiltration reject stream and a reverse osmosis reject stream.

10. A method according to claim 9 further comprising the sub-step of using the recovered energy to reduce a feed pumping power.

11. A method according to claim 9 further comprising the sub-step of using the recovered energy to provide an inter-stage pressure boost.
